(19) United States
(12) Patent Application Publication
(10) Pub. No.: US 2025/0069404 A1
(43) Pub. Date: Feb. 27, 2025

(54) SYSTEM AND METHOD FOR CONTINUOUS FLAME QUALITY ASSESSMENT OF INDUSTRIAL BURNERS

(71) Applicant: PETRÓLEO BRASILEIRO S.A. – PETROBRAS, Rio de Janeiro (BR)

(72) Inventors: ANDRE SEICHI RIBEIRO KURAMOTO, São José dos Campos (BR); VITOR VALE DO NASCIMENTO, Ipojuca (BR)

(73) Assignee: PETRÓLEO BRASILEIRO S.A. – PETROBRAS, Rio de Janeiro (BR)

(21) Appl. No.: 18/767,002

(22) Filed: Jul. 9, 2024

(30) Foreign Application Priority Data
Aug. 22, 2023 (BR) 1020230168337

(51) Int. Cl. G06V 20/52; G01J 5/00; G01J 5/48; G06V 10/774

(52) U.S. Cl. CPC G06V 20/52; G01J 5/48; G06V 10/774; G01J 2005/0077; G06V 2201/06

(57) ABSTRACT

The present invention discloses a system and method for continuous flame quality assessment of industrial burners. According to a preferred embodiment of the present invention, it comprises at least one camera, intrusively installed in a combustion chamber comprising a plurality of burners, an image flow manager to obtain camera image sets and perform digital treatments and provide digital images through data flows. Furthermore, an edge computer is provided to consume image sets provided from the image flow manager, process the images by running artificial intelligence models to locate and identify each burner and classify its respective flame state, and generate possible alerts regarding the flame state of the respective burners. Furthermore, an alert manager, a data historian, a supervision system, and cloud storage and computing are provided.

### FIELD OF THE INVENTION

The present invention refers to the technical field of quality control technologies for burning gases in industrial furnace and boiler burners. More specifically, the present invention relates to a system and method for continuous flame quality assessment of industrial burners.

### BACKGROUND OF THE INVENTION

Furnace and boiler burners are designed to achieve high burning efficiency, minimizing greenhouse gas emissions and maximizing the energy added to the furnace or boiler.

For the burners to operate with optimal burning efficiency, there must be no deposition of residues that change the flow of fuel or air through the burner. Additionally, the amount of fuel and air flowing through the burners must be in adjusted proportions to obtain optimal burning efficiency; that is, simultaneously maximizing the energy transfer to the product to be heated and minimizing the greenhouse gases emission. A burner operating in a non-optimized condition may be emitting unburned or incompletely burned fuel into the environment.

Both the existence of residue deposition in the burner and the non-optimal adjustment of the air and fuel proportion are diagnosed by observing the burner flame. The furnaces and boilers have “inspection windows” to observe the operating condition of the burners, as well as an intrusively installed video camera focusing on the burners to allow remote observation.

The amount of fuel is adjusted using control valves. The total amount of air admitted into a furnace or boiler is adjusted through variations in the flow rate of electric or turbine blowers, or is naturally admitted into the equipment through a pressure differential.

Individual adjustment of the air flow rate for each burner; that is, the distribution of air between the burners, is traditionally done manually using “ferrules” installed in the air duct of each burner. Adjustment is necessary as changes in the operating point of the furnace or boiler; that is, changes in the fuel flow rate and consequently in the total air flow rate (change in the operating point of the air blower) cause changes in the proportions of individual air distribution to the burners.

Therefore, to obtain optimal burning efficiency in furnace and boiler burners, it must be ensured that there is no residue deposited in the burners and that the air adjustment is optimal for the amount of fuel. If one or both these characteristics are not guaranteed, the burner's burning efficiency will not be optimal, and this condition will be visible through the “inspection window” or camera.

Traditionally, operational staff observes the flames of furnace and boiler burners not continuously, but periodically, given the various other team assignments. When diagnosing a non-optimized burn in one or more burners, the operating technician adjusts the air flow rate by acting on the “ferrule” relative to that burner. If he is unsuccessful in achieving optimized burning, the technician requests maintenance from the Plant's local team assuming that there are residues deposited in the burner, or other degradations that warrants diagnosis and maintenance.

### STATE OF THE ART

The State of the Art contains the disclosure of some documents that teach about the quality control of the gases burning in the burners of industrial furnaces and boilers.

Document U.S. Pat. No. 11,513,496 discloses a method of monitoring and controlling an industrial process, which includes capturing images of a non-sensible process condition of the industrial process with an image capture device, receiving the images of the non-sensible process condition with a computer system and converting each image into a corresponding numeric value with a machine learning model stored in and operable by the computer system. The corresponding numeric value is then received and compared to a predetermined numeric value for the non-sensible process condition with a closed-loop controller, and an actuator operates with the closed-loop controller to adjust operation of the industrial process when the corresponding numeric value fails to match the predetermined numeric value or is outside of a defined threshold near the predetermined numeric value.

Document CN109442474 discloses a kind of flame detection device of gasification furnace and detection method, which are made of furnace flame image capturing system, CCD camera, intelligent flame analysis system and ancillary equipment. However, similarly to document U.S. Pat. No. 11,513,496, said document describes an image analysis method generating a signal (a numerical value) for each image.

Therefore, it is observed that in document U.S. Pat. No. 11,513,496 and CN109442474 each image is converted into a numerical value. Differently, in the present invention, in each image a detector algorithm automatically finds multiple regions that contain burners and the individual analysis of each of the burners is also carried out in an automated way. Therefore, for each image, the proposed invention generates multiple numerical values (and not just one numerical value) relating to the state of each of the burners. Furthermore, in the present invention, it does not matter if image displacements occur, as the algorithm automatically locates the regions of the image where there are burners so that the analysis can be carried out individually. Therefore, when compared to documents U.S. Pat. No. 11,513,496 and CN109442474, the present invention is intrinsically robust to image shifts.

Document CN105678295 discloses a method for real-time monitoring of the gas heating furnace flame based on ROI average image analysis which belongs to the field of monitoring industrial heating furnace flame video.

It is observed that in the aforementioned document, the human-computer interaction is necessary to define the ROI (flame region of interest), while in the present invention the regions of interest (burner flames) are identified automatically. Therefore, no human-computer interaction is required. This is an important feature, as it makes the invention robust to displacements of the camera and image's position and simplifies system installation, as manual human selection is not necessary. Furthermore, in the present invention, multiple flames (multiple regions of interest) are analyzed simultaneously. Each image can have multiple flames and all of them are analyzed individually, inferring their individual states.

Document U.S. Pat. No. 5,249,954 discloses an integrated imaging sensor/neural network controller for combustion control systems, wherein the controller uses electronic imaging sensing of chemiluminescence from a combustion system, combined with neural network image processing, to sensitively identify and control a complex combustion system. However, document U.S. Pat. No. 5,249,954 deals with a particular case of analyzing a single flame using a camera. Differently, the present invention is suitable for one or multiple burners.

Document CN107729913 discloses boiler furnace Situation Awareness method based on multiple features fusion cluster, which belongs to boiler furnace Situation Awareness method. However, it is noted that the aforementioned document deals with flame detection; that is, whether there is a flame present or not, but apparently there is no automated intelligent analytical system that analyzes the flame state, as well as in the present invention.

Therefore, there remain obvious deficiencies in the state of the art. In view of these deficiencies, the characteristics and advantages of the present invention will clearly emerge from the detailed description below and with reference to the attached drawings, these being provided only as preferred and non-limiting embodiments.

### BRIEF DESCRIPTION OF THE INVENTION

The present invention discloses a system and method for continuous flame quality assessment of industrial burners. According to a preferred embodiment of the present invention, it comprises at least one camera (3), intrusively installed in a combustion chamber (1) comprising a plurality of burners (2); an image flow manager (4) to obtain camera image sets (3) and perform digital treatments and provide digital images through data flows. Furthermore, an edge computer (5) is provided to consume image sets provided from the image flow manager (4), process the images by running artificial intelligence models to locate and identify each burner (2) and classify its respective flame state, and generate possible alerts regarding the flame state of the respective burners (2). Furthermore, an alert manager, a data historian (6), a supervision system (7), and cloud storage and computing (12) are provided.

### BRIEF DESCRIPTION OF THE FIGURES

In order to complement the present description and obtain a better understanding of the characteristics of the present invention, figures are presented in which, in exemplified manner and not limiting, its preferred embodiments are represented.

FIG. 1 illustrates some components of the present invention and their possible interconnections.

FIG. 2D illustrates a combustion chamber with non-optimized flame burners.

FIG. 2E illustrates a combustion chamber with flame-optimized burners.

### DETAILED DESCRIPTION OF THE INVENTION

The present invention relates to a system and method for continuous flame quality assessment of industrial burners.

It will be appreciated that the visible characteristics, such as flame's shape and color of each burner of an industrial furnace or boiler, change due to the occurrence of residue deposition in the burner and as a function of the non-optimal adjustment adequacy of the air and fuel ratio.

Commonly, the amount of fuel is adjusted through control valves and the total amount of air admitted into a furnace or boiler is adjusted through variations in the flow rate of electric or turbine blowers or is naturally admitted into the equipment through a pressure differential.

Individual adjustment of the air flow rate for each burner; that is, the distribution of air between the burners, is traditionally done manually using “ferrules” installed in the air duct of each burner. Adjustment is necessary as changes in the operating point of the furnace or boiler; that is, changes in the fuel flow rate and consequently in the total air flow rate (change in the operating point of the air blower) cause changes in the proportions of individual air distribution to the burners.

In general, the system and method of the present invention apply machine learning and computer vision techniques, continuously processing the images obtained by an intrusive video camera in a combustion chamber, locating in the images the burner flames in operation, classifying them and generating alerts based on flame classification.

Each region of the images, where flames are automatically located, is classified into optimized, non-optimized states, or images with insufficient information to identify the flame quality. After classification, alerts for occurrences of non-optimized flames and variations in the number of burners with optimized and non-optimized flames are generated. Alerts are registered to be used as a source of information for evaluating performance and the need for maintenance intervention on the burners.

Furthermore, the location of each burner in the video camera images operation is carried out using artificial intelligence (AI), specifically the deep learning models (deep learning). The identification of each burner flame state (optimized or non-optimized) is also obtained by deep learning models.

Due to changes in the operating point of the furnace or boiler, a set of sequential images must be considered to consistently obtain the flame state. Therefore, the heuristic use is proposed to combine the identifications of the flame state and, thus, obtain an assertive result for each of the burners located in the processed images set. This classification of the image set is used to generate alerts for the supervision system and data historian. Continuous monitoring of burner flames with appropriate alerts to the furnace and boiler operation and maintenance team, as well as burner adjustment and maintenance actions, aims to maximize the energy efficiency of furnaces and boilers and minimize emissions.

More specifically, the present invention is applicable to a combustion chamber of a furnace or boiler. Said combustion chamber is the part of the equipment (furnace or boiler) in which a plurality of burners is located, as well as a video camera for monitoring the burner flames.

The video camera, which is preferably of the visible or thermographic spectrum, is placed in a suitable position to continuously capture images of the respective flames of the plurality of burners within the combustion chamber of the furnace or boiler.

It will be appreciated by one skilled in the art that the camera has lenses, filters, and sensors capable of presenting the image of the flame with sufficient sharpness and luminosity to discern colors of the flame. Furthermore, the camera may preferably have continuous and automated lens cleaning capabilities to ensure continuity of monitoring. The camera images are provided to an image flow manager, which is a computerized system with the ability to perform digital treatments and provide digital images by flow data using the Real Time Streaming Protocol (RTSP).

The image flow manager preferably enables the capture of data streams with a resolution of between 640×480 pixels and 3840×2160 pixels (4K) or higher, and a refresh rate of at least 1 FPS (frame per second). The image flow manager is preferably connected to a computer network capable of establishing the RTSP data flow at least in the aforementioned resolutions and refresh rates.

It is also provided an edge computer, which is a computational resource hosted in the industrial unit domain (on premises) with an installed application capable of performing at least the following activities:
1. Consuming sets of few dozen images from the image flow manager through the RTSP data flow mentioned above, process them by locating the burners in operation, and identify the flame state and each burner. There are three possible flame states of a burner: optimized flame, non-optimized flame, and image with insufficient information to identify the flame state. This last class refers to the result of image processing not being assertive regarding the flame state. The number of images in the image set is a configuration parameter of the present invention. Each of the images is previously processed with computer vision techniques to highlight important characteristics for the next processing steps. The location in the images of burners in operation, as well as the identification of the flame state (optimized or not), occurs through artificial intelligence (AI), specifically deep learning models (deep learning) applied to each of the images in the set. The result of the state inference of each burner flame is combined using heuristics to obtain the states that best represent the burners located in the total set of images.
2. Sending data to an alert manager so that the identified flame state is recorded as an alert event, with visibility for the group of users who operate the furnaces and boilers in the industrial unit. Thus, users receive the updated status of the burner flames on the supervisory system's operational screen. The alert is sent after the processing of each set of images is completed.
3. Sending the following data resulting from the processing of the image set to a data historian: number of images processed in the set, number of burners in operation with flames classified in each class (status), result (accuracy) of the individual processing of each flame image etc. The data is sent to the data historian after the processing of each image set is completed; and
4. Sending data to a cloud storage and computing resource that is also sent to the data historian, in addition to processed image samples from the image set. The data and image samples are sent to the cloud storage and computing resource after the processing of each set of images is completed.

A supervisory system consumes the results sent by the edge computer from the data historian (edge computer), in addition to presenting operational alerts for the flame state. If there are warnings of burners with non-optimized flames, the operational team acts to adjust the burner's individual air supply using the air adjustment “ferrules”, or initiates a diagnosis locally next to the furnace or boiler to identify the possible cause of the non-optimization state of the flame, such as, for example, deposition of residues in the burner's air or fuel flow paths. The action on the “ferroles” occurs in order to minimize the amount of air for the amount of gas required, in order to maximize the energy efficiency of the burner and minimize environmental emissions.

The present invention also provides for the use of information visualization panels that present invention operability data, such as, operational information visualization panels of the invention (8) and historical information visualization panels of the invention (9). This data is preferably presented in graphs, images and tables and can comprise all the information sent by the edge computer to the cloud and the data historian. Additionally, operating information of the air flow/fuel flow ratio control system is presented, which is available in the data historian. The information is presented in a format suitable for the management and maintenance of industrial burners.

The information can preferably be presented in an integrated control center of the industrial unit (10), where are the operation technicians that monitor the alerts (11) also used by technicians that evaluate the performance of the industrial equipment (in this case, furnaces and boilers).

Cloud storage and computing, according to a preferred embodiment of the present invention, brings a set of resources for:
1. Training the artificial intelligence model to be used on the edge computer (edge computer) to infer the flame state.
2. Annotating the new images to compose the model's training and testing databases.
3. Database to store edge computer processing information and samples of the processed images. This database serves the information visualization panels and the process of annotating new images to compose the databases for analysis, training, and testing of the image classification model (processing).

It will be appreciated that the edge computer consumes flame image sets through the image flow manage and performs the four steps mentioned above. All this information is sent to:
1. Alert manager as a visible event record for the furnace or boiler operating team to know the flame state estimated by the assessment method.
2. Data historian.
3. Cloud storage and computing with the aim of improving the model (retraining) and presenting information in information visualization panels. Additionally, processed image samples are sent.

It will also be appreciated if all management and maintenance information for the assessment method is available in the information visualization panels.

Furthermore, in cloud storage and computing there are resources for image annotation and retraining of the processing model (location and individual classification of the flame state) of the images. Information from image processing and processed image samples make up the sets of images (data) for training and testing AI (Artificial Intelligence) models.

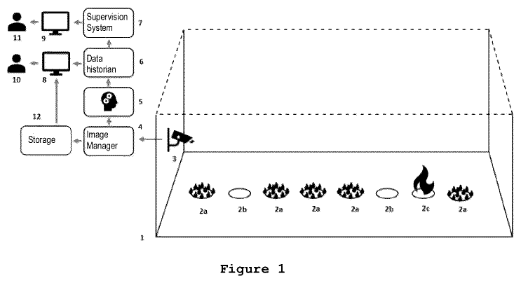

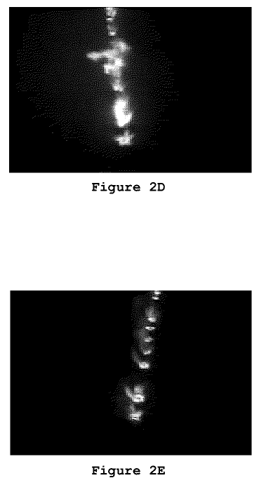

AI models aim to locate the burners in operation in the images, identify (inference) the flame state of each burner, classifying it into one of the states (classes): optimized flame, non-optimized flame, or negative state; in this case, images with insufficient information to classify them as one of the previous states. In FIG. 1, there are schematic drawings that represent the flame state optimized (2a), non-optimized (2c), and negative state (2b). In FIG. 2D, images of the interior of a combustion chamber of an industrial oven with two burners in operation with non-optimized flame state are shown, and in FIG. 2E, with all burners in operation with flames in optimized states.

A cloud computing resource is used to annotate the images and train of the AI model. The images are obtained through videos recorded continuously by the image manager. The videos are sampled generating images to be used for training the model. Images are divided into datasets (datasets) for training and testing the models. With the training dataset the model train is carried out. The test dataset is used to evaluate the performance of the models. The model performance calculation is performed by cloud computing using the trained models and the test dataset.

Cloud storage is also used historically to store image samples and metadata generated by AI models running on the edge computer in real time. Images with localized burners and flames classified on the edge computer with lower confidence are highlighted for a skilled in the art to analyze such scenarios and, if applicable, propose a new annotation and perform retraining of the AI models.

It will be appreciated that each image to be used for training and testing the AI models, as well as for real-time inference, is previously processed using computer vision techniques. Some filters are applied to, for example, minimize noise, adjust colors, reduce distortions caused by the camera's optical assembly associated with the spatial positioning of the burner in the combustion chamber of the furnace or boiler.

### Preferred Embodiments of the Invention

A system for continuous flame quality assessment of industrial burners, according to a preferred embodiment of the present invention, comprises:
one or more cameras (3), intrusively installed in a combustion chamber (1) comprising a plurality of burners (2);
an image flow manager (4) to obtain camera image sets (3) and perform digital treatments and provide digital images through data flows;
an edge computer (5) to consume image sets provided from the image flow manager (4), process the images by running artificial intelligence models to locate and identify each burner (2) and classify its respective flame state, and generate possible alerts regarding the flame state of the respective burners (2);
an alert manager for recording the identified flame state of each burner (2) received from the edge computer (5) as possible alerts and sending the possible alerts upon completion of processing each set of images;
a data historian (6) to receive possible alerts of the alert manager and to history the resulting data from the processing of the image set by the edge computer (5);
a supervision system (7) to consume from the data historian (6) the results sent by the edge computer (5) and present alerts of the flame state received of the alert manager; and
a storage and computing cloud (12), to store processing information from the edge computer (5) and samples of the processed images, training the artificial intelligence model and annotation of new images to compose training and testing databases of the artificial intelligence model.

Wherein the camera is preferably a visible or thermographic spectrum camera.

Wherein the edge computer (5) individually locates and classifies the plurality of burners according to at least the states of: optimized flame, non-operational, non-optimized flame.

Wherein the supervision system can present data in panels for visualization by operational and maintenance teams.

Wherein the image flow manager is a computerized system with the ability to perform digital treatments and provide digital images through data flows using the Real Time Streaming Protocol (RTSP), and wherein the image flow manager is connected to a computer network capable of establishing the RTSP data flow.

Wherein one of the data flows of image flow manager is configured for resolution between 640×48 pixels and 3840×2160 pixels or higher, and a refresh rate of at least 1 FPS.

Furthermore, a method of continuous flame quality assessment of industrial burners, according to a preferred embodiment of the present invention, comprises at least the steps of:
receiving, by means of an image flow manager (4), image sets from a camera (3) intrusively installed in a combustion chamber (1) comprising a plurality of burners (2), wherein the manager image flow (4) performs digital processing and provides digital images through data flows;
consuming, through an edge computer (5), the image sets provided from the image flow manager (4), and processing the images by running artificial intelligence models to locate and identify each burner (2) and its respective flame state, and generating possible alerts regarding the flame state of the respective burners (2);
register, through an alert manager, the identified flame state of each burner (2) received from the edge computer (5) as possible alerts and send the possible alerts upon conclusion of the processing of each image set;
receiving, through a data historian (6), possible alerts of the alert manager and the data resulting from the processing of the image set by the edge computer (5);
consuming and presenting, through a supervisory system (7), data from the data historian (6) and the results sent by the edge computer (5), and presenting flame state alerts received of the alert manager; and
storing, through cloud storage and computing (12), the processing information of the edge computer (5) and samples of the processed images, wherein the cloud storage and computing (12) also performs training and testing of the artificial intelligence model and the annotation of new images to compose training and testing databases of the artificial intelligence model.

Wherein the edge computer (5) further comprises the step of classifying the plurality of burners according to at least the states of: optimized flame, non-operational, non-optimized flame.

Wherein the supervision system also comprises presenting data in panels for viewing by operational and maintenance teams.

Wherein the image flow manager is a computerized system with the ability to perform digital treatments and provide digital images through data flows using the Real Time Streaming Protocol (RTSP), and wherein the image flow manager is connected to a computer network capable of establishing the RTSP data flow.

Wherein one of the data flows of the image flow manager is configured for resolution between 640×480 pixels and 3840×2160 pixels or higher, and refresh rate of at least 1 FPS.

Those skilled in the art will value the knowledge presented herein and will be able to reproduce the invention in the presented embodiments and in other variants, covered within the scope of the appended claims.

1. System for continuous flame quality assessment of industrial burners, the system comprising:
a camera, intrusively installed in a combustion chamber comprising a plurality of burners;
an image flow manager to obtain camera image sets and perform digital treatments and provide digital images through data flows;
an edge computer to consume image sets provided from the image flow manager, process the images by running artificial intelligence models to locate and identify each burner and classify its respective flame state, and generate possible alerts regarding the flame state of the respective burners;
an alert manager for recording the identified flame state of each burner received from the edge computer as possible alerts and sending the possible alerts upon completion of processing each set of images;
a data historian to receive possible alerts of the alert manager and to history the data resulting from the processing of the image set by the edge computer;
a supervisory system to consume from the data historian the results sent by the edge computer and present flame state alerts received from the alert manager; and
a storage and computing cloud, to store processing information from the edge computer and samples of the processed images, and training the artificial intelligence model and annotation of new images to compose training and testing databases of the artificial intelligence model.

2. System for continuous flame quality assessment of industrial burners, according to claim 1, wherein the camera is preferably a visible or thermographic spectrum camera.

3. System for continuous flame quality assessment of industrial burners, according to claim 1, wherein the edge computer classifies the plurality of burners according to at least the states of: optimized flame, non-operational, non-optimized flame.

4. System for continuous flame quality assessment of industrial burners, according to claim 1, wherein the supervision system can present data in panels for visualization by operational and maintenance teams.

5. System for continuous flame quality assessment of industrial burners, according to claim 1, wherein the image flow manager is a computerized system with the ability to perform digital treatments and provide digital images through data flows using the Real Time Streaming Protocol, and wherein the image flow manager is connected to a computer network capable of establishing the RTSP data flow.

6. System for continuous flame quality assessment of industrial burners, according to claim 5, wherein one of the data flows of the data flow manager is configured for resolution between 640×480 pixels and 3840×2160 pixels or higher, and refresh rate of at least 1 FPS.

7. Method of continuous flame quality assessment of industrial burners, according to the system of claim 1, characterized in that it wherein the method comprises at least the steps of:
receiving, by means of an image flow manager, image sets from a camera intrusively installed in a combustion chamber comprising a plurality of burners, wherein the manager image flow performs digital treatments and provides digital images through data flows;
consuming, through an edge computer, the image sets provided from the image flow manager, and processing the images by running artificial intelligence models to locate and identify each burner and its respective flame state, and generating possible alerts regarding the flame state of the respective burners;
registering, through an alert manager, the identified flame state of each burner received from the edge computer as possible alerts and send the possible alerts upon conclusion of the processing of each image set;
receiving, through a data historian, the possible alerts of the alert manager and the data resulting from the processing of the image set by the edge computer;
consuming and presenting, through a supervision system, data from the data historian and the results sent by the edge computer and presenting flame state alerts received of the alert manager; and
storing, through cloud storage and computing, the processing information of the edge computer and samples of the processed images, wherein the cloud storage and computing also performs training and testing of the artificial intelligence model and the annotation of new images to compose training and testing databases of the artificial intelligence model.

8. Method of continuous flame quality assessment of industrial burners, according to the claim 7, wherein the edge computer further comprises the step of classifying the plurality of burners according to at least the states of:
optimized flame, non-operational, non-optimized flame.

9. Method of continuous flame quality assessment of industrial burners, according to claim 7, wherein the supervision system also comprises presenting data in panels for visualization by operational and maintenance teams.

10. Method of continuous flame quality assessment of industrial burners, according to claim 7, wherein the image flow manager is a computerized system capable of performing digital treatments and provide digital images through data flows using the Real Time Streaming Protocol (RTSP), and wherein the image flow manager is connected to a computer network capable of establishing the RTSP data flow.

11. Method of continuous flame quality assessment of industrial burners, according to claim 10, wherein one of the data flows of the image flow manager is configured for resolution between 640×480 pixels and 3840×2160 pixels or higher, and refresh rate of at least 1 FPS.
